(19) United States
(12) Patent Application Publication
(10) Pub. No.: US 2011/0058111 A1
(43) Pub. Date: Mar. 10, 2011

(54) LIQUID CRYSTAL DISPLAY DEVICE, DRIVING METHOD AND ELECTRONIC DEVICE

(75) Inventors: Hiroyuki HOSAKA, Matsumoto-shi (JP); Hidehito IISAKA, Shiojiri-shi (JP)

(73) Assignee: SEIKO EPSON CORPORATION, Tokyo (JP)

(21) Appl. No.: 12/859,392

(22) Filed: Aug. 19, 2010

(30) Foreign Application Priority Data
Sep. 7, 2009 (JP) 2009-205682

(51) Int. Cl. H04N 3/10

(52) U.S. Cl. 348/792; 348/E03.011

(57) ABSTRACT

A liquid crystal display device includes: pixel that corresponds to intersection of scanning line and data line and that each change the transmittance or reflectance of a liquid crystal element by means of a pair of electrodes; a scanning line driving circuit that selects scanning line and applies a selection voltage to the selected scanning line; and a data line driving circuit that applies writing voltages through the data line to the pixel that corresponds to the selected scanning line, wherein the scanning line driving circuit applies the selection voltage to the selected scanning line for video signal writing periods and setting periods that start before the video signal writing periods, respectively, the data line driving circuit supplies, to the pixel, data signals with voltages corresponding to video signals for the video signal writing periods and supplies, to the pixel, a setting signal with a predetermined voltage for the setting periods, and each of the setting periods is shorter than a response time required for the transmittance or reflectance of each of the liquid crystal element to change from 0% to 100% or a response time required for the transmittance or reflectance of each of the liquid crystal element to change from 100% to 0%.

### BACKGROUND

1. Technical Field

The present invention relates to a technique for suppressing the occurrence of a display error in a liquid crystal display device.

2. Related Art

A liquid crystal panel includes: pixel electrodes that are provided for pixels and arranged in a matrix form on a substrate; and a common electrode that is arranged on another substrate and extends across the pixels. Liquid crystal is provided between the pixel electrodes and the common electrode. When voltages that correspond to gradations are applied and maintained between the pixel electrodes and the common electrode, the molecular orientation of the liquid crystal is determined for each of the pixels so that the transmittance or reflectance of the pixel is controlled. Thus, only components (applied in a direction between the pixel electrodes and the common electrode or in a direction (vertical direction) perpendicular to the surfaces of the substrates) of an electric field that acts on liquid crystal molecules contribute to controlling the display.

In recent years, intervals between pixels have been reduced in order to reduce the sizes of liquid crystal panels and increase the resolution of images that are to be displayed on the liquid crystal panels. Thus, an electric field may be generated between adjacent pixel electrodes and applied in a direction (horizontal direction) parallel to the surface of a substrate. Effects of the electric field cannot be ignored. For example, when an electric field is applied in the horizontal direction to liquid crystal that is to be driven by an electric field applied in a vertical direction through a vertical alignment (VA) method or a twisted nematic (TN) method, the liquid crystal molecules are not correctly oriented (or a reverse tilt domain is formed) and a display error occurs.

In order to suppress an effect of the reverse tilt domain, a technique (refer to, for example, JP-A-6-34965 (FIG. 1)) has been proposed to creatively provide the structure of a liquid crystal panel by defining the shape of a light shielding layer (opening section) on the basis of pixel electrodes, and another technique (refer to, for example, JP-A-2009-69608 (FIG. 2)) has been proposed to determine that a reverse tilt domain is formed when the average brightness value calculated on the basis of video signals is not larger than a threshold and to clip a video signal with a value that is larger than a set value on the basis of the determination.

However, the technique for creatively providing the structure of the liquid crystal panel to reduce the effect of the reverse tilt domain has disadvantages that the aperture ratio of the liquid crystal panel is easily reduced and this technique cannot be applied to liquid crystal panels that have already been made without consideration of the structures of the liquid crystal panels. The technique for clipping a video signal with a value that is larger than the set value has a disadvantage that the brightness of an image displayed is limited to a set value.

### SUMMARY

An advantage of some aspects of the invention is that it provides a technique for reducing a reverse tilt domain while eliminating the aforementioned disadvantages.

According to a first aspect of the invention, a liquid crystal display device includes: pixel that corresponds to intersection of a plurality of scanning line and a plurality of data line and that each include a liquid crystal element having liquid crystal provided between a pixel electrode and a common electrode and a switching element that electrically connects the pixel electrode to the data line that corresponds to the liquid crystal element when a selection voltage is applied to the scanning line that corresponds to the liquid crystal element; a scanning line driving circuit that selects scanning line and applies the selection voltage to the selected scanning line for video signal writing periods each of which starts after a time interval elapses after the end of another one of the video signal writing periods, selects one of the plurality of scanning line and applies the selection voltage to the selected scanning line for a setting period included in the time interval that starts earlier by a predetermined time than the time when the selection voltage is applied to the selected scanning line; and a data line driving circuit that supplies, to the pixel through the data line, data signals with voltages corresponding to video signals for the video signal writing periods and supplies, through the data line to the pixel, a setting signal with a predetermined voltage for setting periods, wherein the predetermined time is shorter than a response time required for the transmittance or reflectance of each of the liquid crystal element to change from 0% to 100% or a response time required for the transmittance or reflectance of each of the liquid crystal element to change from 100% to 0%. According to the first aspect of the invention, it is possible to suppress the formation of a reverse tilt domain. Since an aperture ratio is not reduced, the liquid crystal display device can be applied to liquid crystal panels that have already been made without consideration of the structures of the liquid crystal panels. Also, the brightness of an image displayed is not restricted to a set value.

According to the first aspect of the invention, it is preferable that the predetermined time be set to 1 millisecond or less. When the predetermined time is set to 1 millisecond or less, the transmittance (or reflectance) of each of the liquid crystal element is almost not changed by the setting signal. According to a second aspect of the invention, in the liquid crystal display device according to the first aspect of the invention, it is preferable that the setting signal be a voltage that causes the voltages applied to the liquid crystal element to be equal to or larger than an optical saturated voltage. In this case, liquid crystal molecules are not affected by an electric field applied in a horizontal direction. According to a third aspect of the invention, in the liquid crystal display device according to the first aspect of the invention, it is preferable that the video signal writing periods be horizontal effective scanning periods for the video signals and the setting periods be included in horizontal blanking periods for the video signals.

According to the third aspect of the invention, it is preferable that the data line driving circuit supply the setting signal and the data signals, each of which have a positive or negative polarity with respect to a predetermined reference potential, and when the selection voltage is to be applied to the selected scanning line for the horizontal effective scanning period after the selection voltage is applied to the selected scanning line for the setting period, the polarity of the setting signal supplied for the setting period be the same as the polarities of the data signals supplied for the horizontal effective scanning period.

According to the third aspect of the invention, it is preferable that the data line driving circuit alternately supply, to the plurality of data line, the setting signal and a signal other than the setting signal for the setting periods. According to the third aspect of the invention, it is preferable that the data line driving circuit repeat the supply of the setting signal to the plurality of the data line for every other setting period and the supply of a signal other than the setting signal to the plurality of the data line for the next setting period. In this case, the predetermined time is close to the response time, and it is possible to suppress the occurrence of a change in the brightness of an image displayed.

The invention can be applied to a method for driving the liquid crystal display device and an electronic device that includes the liquid crystal display device, in addition to the liquid crystal display device.

### BRIEF DESCRIPTION OF THE DRAWINGS

The invention will be described with reference to the accompanying drawings, wherein like numbers reference like elements.

FIG. 1 is a diagram showing a liquid crystal display device according to an embodiment of the invention.

FIG. 2 is a diagram showing equivalent circuits each of which has a liquid crystal element and is included in the liquid crystal display device.

FIG. 3 is a diagram showing the configuration of a conversion circuit that is included in the liquid crystal display device.

FIGS. 4A and 4B are diagrams showing voltage-transmittance characteristics of the liquid crystal display device.

FIGS. 5A to 5C are diagrams showing optical response characteristics of the liquid crystal display device.

FIG. 6 is a diagram showing a part of the response characteristics of the liquid crystal display device.

FIG. 7 is a diagram showing operations of the conversion circuit and the like that are included in the liquid crystal display device.

FIG. 8 is a diagram showing operations of a data line driving circuit that is included in the liquid crystal display device.

FIGS. 9A and 9B are diagrams showing a writing process performed by the liquid crystal display device.

FIG. 10 is a diagram showing a writing process in a modified example.

FIGS. 11A to 11C are diagrams showing a writing process in another modified example.

FIG. 12 is a diagram showing a projector to which the liquid crystal display device is applied.

### DESCRIPTION OF EXEMPLARY EMBODIMENT

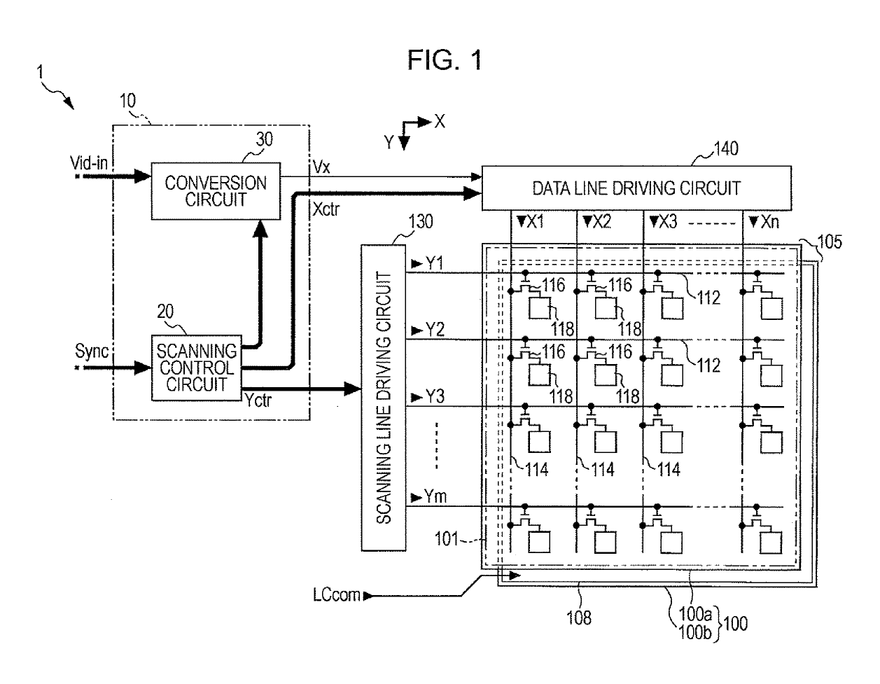

An embodiment of the invention is described below with reference to the accompanying drawings. FIG. 1 is a block diagram showing the entire configuration of a liquid crystal display device according to the embodiment.

As shown in FIG. 1, a liquid crystal display device 1 includes a control circuit 10, a liquid crystal panel 100, a scanning line driving circuit 130 and a data line driving circuit 140. Video signals Vid-in are supplied to the control circuit 10 from a higher-level device in synchronization with a synchronization signal Sync and are digital data pieces that specify gradations of pixels that are displayed in the liquid crystal panel 100. In this case, the video signals Vid-in are supplied in order of scanning that is performed based on a vertical scanning signal, a horizontal scanning signal and a dot clock signal, which are included in the synchronization signal Sync (and not shown).

The control circuit 10 includes a scanning control circuit 20 and a conversion circuit 30. The scanning control circuit 20 generates various control signals and controls each section in synchronization with the synchronization signal Sync. The conversion circuit 30 processes the digital video signals Vid-in and outputs analog data signals Vx.

The liquid crystal panel 100 includes an element substrate (first substrate) 100a and a counter substrate (second substrate) 100b. The element substrate 100a and the counter substrate 100b are stacked on top of each other, while a certain gap is located between the element substrate 100a and the counter substrate 100b. Liquid crystal 105 is provided in the gap and driven by an electric field applied in a vertical direction.

A plurality of scanning lines 112 are arranged in m rows on a surface (facing the counter substrate 100b) of the element substrate 100a and extend in an X (horizontal) direction. In addition, a plurality of data lines 114 are arranged in n columns on the surface of the element substrate 100a and extend in a Y (vertical) direction. The data lines 114 are electrically insulated with respect to the scanning lines 112.

In the present embodiment, the scanning lines 112 are called scanning lines arranged in order in the 1st, 2nd, 3rd, (m−1)-th and m-th rows, from the top of FIG. 1 in some cases in order to distinguish the scanning lines 112 from each other. Similarly, the data lines 114 are called data lines arranged in order in the 1st, 2nd, 3rd, (n−1)-th and n-th columns, from the left side of FIG. 1 in some cases in order to distinguish the data lines 114 from each other.

In addition, pairs of an N channel thin film transistor (hereinafter abbreviated as TFT) 116 and a rectangular transparent pixel electrode 118 are arranged on the element substrate 100a and correspond to intersections of the scanning lines 112 and the data lines 114. The TFTs 116 function as switching elements. Gate electrodes of the TFTs 116 are connected to the scanning lines 112. Source electrodes of the TFTs 116 are connected to the data lines 114. Drain electrodes of the TFTs 116 are connected to the pixel electrodes 118.

A transparent common electrode 108 is arranged on an entire surface (facing the element substrate 100a) of the counter substrate 100b. A voltage LCcom is applied to the common electrode 108 by a circuit (not shown).

In FIG. 1, the surface of the element substrate 100a, which faces the counter substrate 100b, faces the back side of the sheet of FIG. 1. Thus, the scanning lines 112, the data lines 114, the TFTs 116 and the pixel electrodes 118 need to be illustrated by broken lines, but are illustrated by solid lines in FIG. 1 in order to clarify the scanning lines 112, the data lines 114, the TFTs 116 and the pixel electrodes 118.

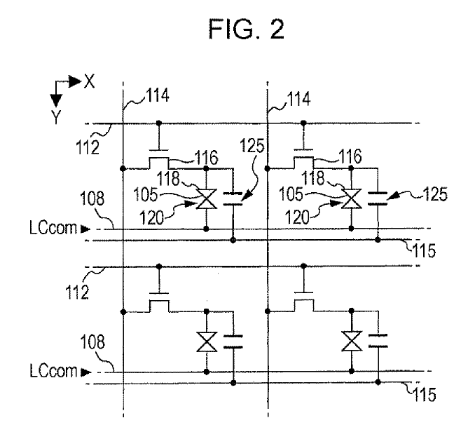

FIG. 2 shows some of the equivalent circuits that are included in the liquid crystal panel 100. Each of the equivalent circuits has a liquid crystal element 120. The positions of the liquid crystal elements 120 correspond to the intersections of the scanning lines 112 and the data lines 114 and have liquid crystal 105 provided between the pixel electrodes 118 and the common electrode 108.

In each of the equivalent circuits included in the liquid crystal panel 100, an auxiliary capacitor (storage capacitor) 125 is connected to the liquid crystal element 120 in parallel as shown in FIG. 2, although the auxiliary capacitors 125 are not shown in FIG. 1. Ends of the auxiliary capacitors 125 are connected to the pixel electrodes 118, respectively. The other ends of the auxiliary capacitors 125 are connected to capacitor lines 115. A voltage that is applied to each of the capacitor lines 115 is maintained constant for a certain time.

When a voltage that is applied to a certain one of the scanning lines 112 is changed to a high level, the source and drain electrodes of the TFT 116, the gate electrode of which is connected to the certain scanning line 112, are electrically connected to each other so that the pixel electrode 118 that is connected to the TFT 116 is connected to the data line 114 that is connected to the TFT 116. Thus, when the voltage that is applied to the scanning line 112 is at a high level and a data signal with a voltage that corresponds to a gradation is supplied to the data line 114, the data signal is applied to the pixel electrode 118 through the TFT 116. When the voltage that is applied to the scanning line 112 is changed to a low level, the TFT 116 is turned off. In this case, however, the voltage applied to the pixel electrode 118 is maintained by the capacitive property of the liquid crystal element 120 and the auxiliary capacitor 125.

In each of the liquid crystal elements 120, the molecular orientation of the liquid crystal 105 is changed on the basis of an electric field generated by the pixel electrode 118 and the common electrode 108. When each of the liquid crystal elements 120 is of a transparent type, the transmittance of the liquid crystal element 120 is changed on the basis of the voltage applied to or maintained in the liquid crystal element 120.

The transmittances of the liquid crystal elements 120 included in the liquid crystal panel 100 vary. Thus, the liquid crystal elements 120 correspond to pixels. A region in which the pixels are arranged is regarded as a display region 101. In the present embodiment, the liquid crystal 105 is oriented by the VA method, and when no voltage is applied to the liquid crystal elements 120, the liquid crystal elements 120 are in a black state or a normally black mode.

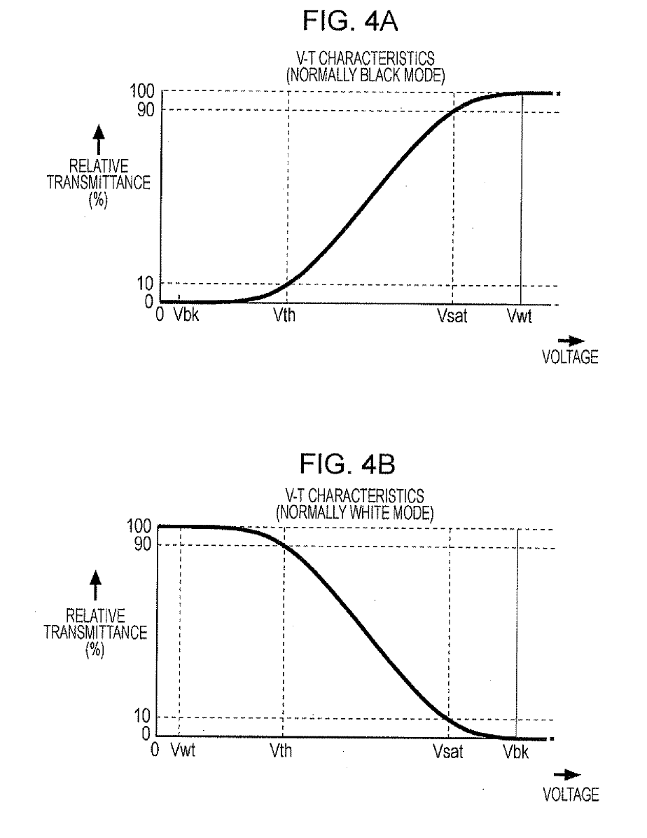

In the present embodiment, the relationship between a voltage applied to each of the liquid crystal elements 120 and the transmittance of the liquid crystal element 120 is represented by voltage-transmittance characteristics shown in FIG. 4A when the liquid crystal element 120 is in the normally black mode. In order to set the transmittance of the liquid crystal element 120 to a value that corresponds to a gradation specified by the video signal Vid-in, a voltage that corresponds to the gradation is applied to the liquid crystal element 120.

However, when voltages that are to be applied to the liquid crystal elements 120 are specified only on the basis of the video signals Vid-in, a display error may occur and be caused by a reverse tilt domain.

One of the reasons for the display error is that when liquid crystal molecules that are included in each of the liquid crystal elements 120 are unstable and misaligned by an electric field applied in the horizontal direction, it is difficult that the liquid crystal is oriented on the basis of the voltage applied in the vertical direction.

When the voltage that is applied to the liquid crystal element 120 is equal to or higher than a voltage Vbk (that causes the pixel (corresponding to the liquid crystal element 120 that is in the normally black mode) to set to a black level) and lower than an optical threshold voltage Vth, the orientation regulating force of the electric field applied in the vertical direction is slightly larger than the orientation regulating force of an oriented film. Thus, the liquid crystal molecules are easily misaligned. In this state, the liquid crystal molecules are unstable.

When the liquid crystal is affected by the electric field applied in the horizontal direction, a potential difference between pixel electrodes that are adjacent to each other is large. In this case, the dark pixel (that is set to the black level or a level close to the black level) and the bright pixel (that is set to a white level or a level close to the white level) are adjacent to each other in an image that is to be displayed.

In the dark pixel, the liquid crystal molecules are easily misaligned. The bright pixel applies the electric field in the horizontal direction to the dark pixel. In order to specify the bright pixel, the bright pixel is regarded as the liquid crystal element 120 to which a voltage that is equal to or higher than an optical saturated voltage Vsat and equal to or lower than a white level voltage Vwt (that causes the pixel (corresponding to the liquid crystal element that is in the normally black mode) to be set to the white level) is applied.

When one of the liquid crystal elements 120, to which a voltage that is lower than the optical threshold voltage Vth is applied, is adjacent to another one of the liquid crystal elements 120, to which a voltage that is equal to or higher than the optical saturated voltage Vsat is applied, it can be said that the liquid crystal element 120, to which a voltage that is lower than the optical threshold voltage Vth is applied, is affected by an electric field applied in the horizontal direction and a reverse tilt domain is easily formed in the liquid crystal element 120.

On the other hand, an electric field applied in the vertical direction is dominant in the liquid crystal element 120 to which a voltage that is not lower than the optical saturated voltage Vsat is applied. Thus, the liquid crystal element 120, to which a voltage that is not lower than the optical saturated voltage Vsat is applied, is stable. Therefore, even when the liquid crystal element 120, to which a voltage that is not lower than the optical saturated voltage Vsat is applied, is adjacent to the liquid crystal element 120 to which a voltage that is lower than the optical threshold voltage Vth is applied, a reverse tilt domain is not formed.

In order to suppress the occurrence of the reverse tilt domain, the following configuration can be considered. That is, the configuration is provided to analyze the video signals Vid-in, detect whether a dark pixel, to which a voltage that is lower than the optical threshold voltage Vth is applied, and a bright pixel, to which a voltage that is not lower than the optical saturated voltage Vsat is applied, are adjacent to each other, and increase the voltage that has been applied to the liquid crystal element of the dark pixel.

However, since the video signals Vid-in need to be analyzed in this configuration, the configurations of the circuits become complicated.

In the present embodiment, a setting voltage that is not lower than the optical saturated voltage Vsat is forcibly applied to each of the liquid crystal elements at a time that is earlier by a time period ΔT than the time at which a voltage based on the video signal is applied to the liquid crystal element. Thus, the trigger is provided to eliminate the effect of an electric field applied in the horizontal direction when the liquid crystal is affected by the electric field applied in the horizontal direction. After the trigger is provided, the voltage based on the video signal is applied to the liquid crystal element.

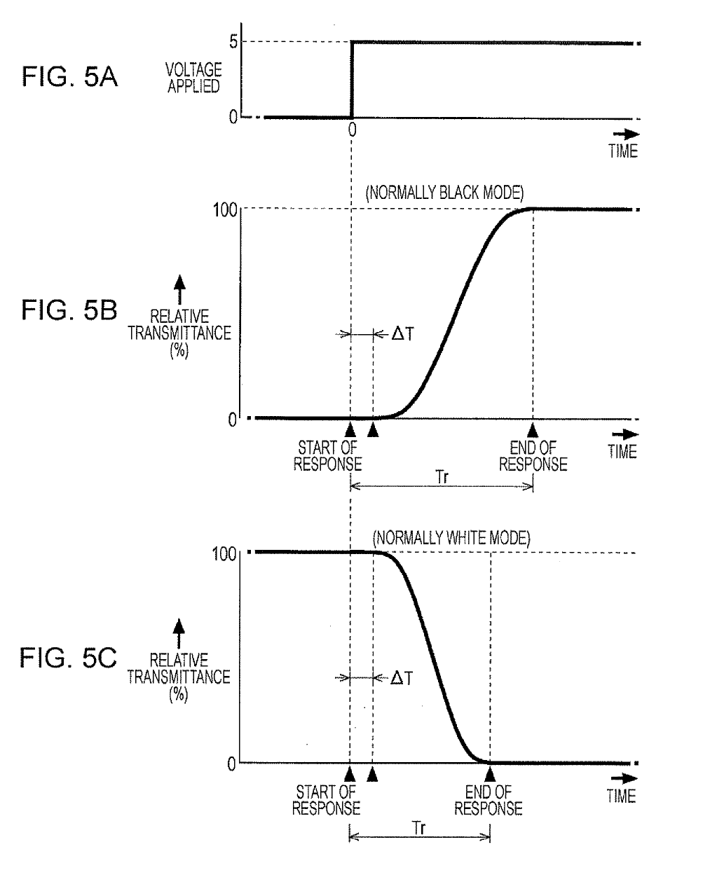

When a voltage of, for example, 5 volts, which corresponds to the white level, is applied to the liquid crystal element 120 that is in a initial state in which the transmittance is “0” (or the voltage applied is zero volts) as shown in FIG. 5A, the transmittance of the liquid crystal element (or the orientation of the liquid crystal molecules) is not changed immediately and is changed after a certain time as shown in FIG. 5B. A response time required for the transmittance of the liquid crystal element to change from 0% to 100% is represented by Tr. If the time period ΔT, between the time when the setting voltage is applied and the time when the voltage based on the video signal is applied, were longer than the response time Tr, the transmittance that is changed to 100% by the application of the setting voltage would be maintained for a time period that is obtained by subtracting the response time Tr from the time period ΔT. In this case, the change in the transmittance (due to the application of the set voltage) may be easily perceived by a user.

In order to prevent the change in the transmittance (due to the application of the set voltage) from being easily perceived by the user, it is preferable that the time period ΔT be set to a value that is shorter than the response time Tr.

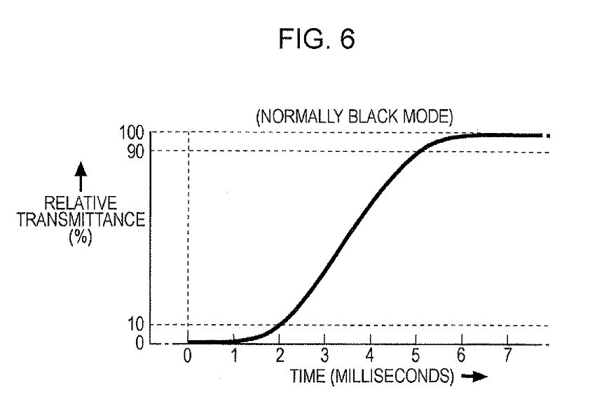

The following describes the response time in more detail. As shown in FIG. 6, a time period required for the liquid crystal molecules to start moving (or a time period required for the transmittance to change) from the initial state (in which the orientations of the liquid crystal molecules are specified only by the oriented film since the voltage applied is zero volts) is approximately 1 millisecond. In other words, 1 millisecond after a voltage of 5 volts is applied, the transmittance remains almost completely unchanged.

When the time period ΔT is set to 1 millisecond or less, the voltage based on the video signal is applied under the condition that the transmittance remains almost completely unchanged by the application of the set voltage. Thus, it is possible that the transmittance is not changed by the application of the set voltage.

In the present embodiment, the setting voltage is applied to each of the liquid crystal elements, and after the time period ΔT elapses after the application of the set voltage, the voltage based on the video signal is applied to the liquid crystal element. Regarding this configuration, the conversion circuit 30, the scanning line driving circuit 130 and the data line driving circuit 140 are described below.

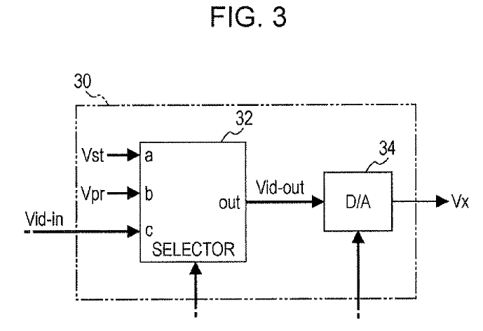

First, the conversion circuit 30 is described. FIG. 3 is a diagram showing the configuration of the conversion circuit 30.

As shown in FIG. 3, the conversion circuit 30 includes a selector 32 and a digital-to-analog (D/A) converter 34.

The scanning control circuit 20 controls the selector 32 so that the selector 32 selects one of input terminals a, b and c and outputs a video signal Vid-out from an output terminal Out. Specifically, a signal Vst that specifies the setting signal is supplied to the input terminal a of the selector 32; a signal Vpr that specifies a precharge signal is supplied to the input terminal b of the selector 32; and the video signals Vid-in are supplied to the input terminal c of the selector 32.

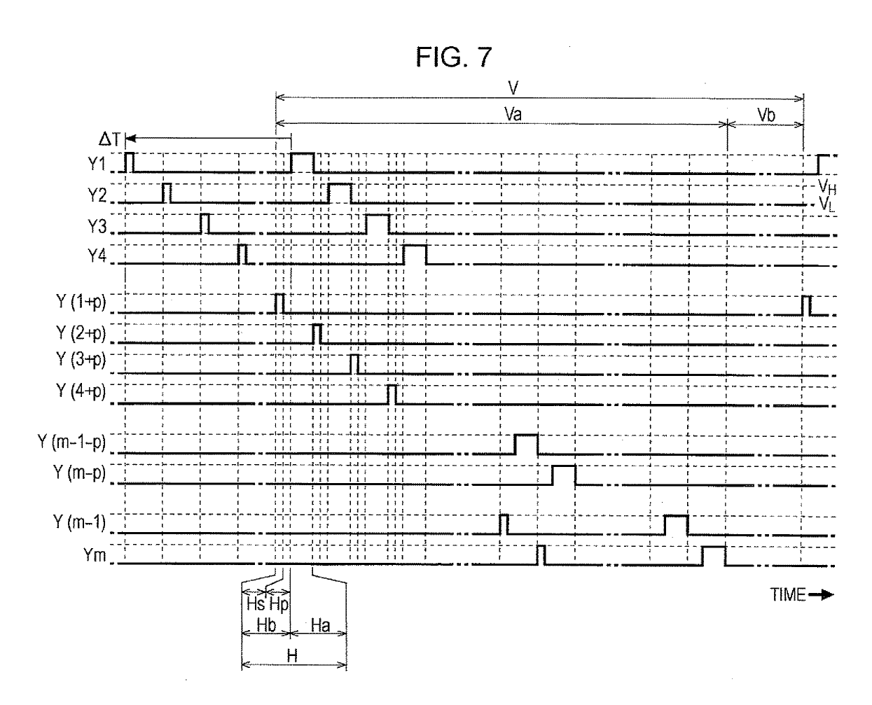

Each of horizontal scanning periods (H), which is specified by the synchronization signal Sync, is divided into a horizontal blanking period (Hb) and a horizontal effective scanning period (Ha). In the present embodiment, each of the horizontal blanking periods (Hb) is divided into an earlier setting period (Hs) and a later precharge period (Hp) as shown in FIG. 7.

The scanning control circuit 20 controls the selector 32 so that the selector 32 selects the input terminal a for the setting periods (Hs), selects the input terminal b for the precharge periods (Hp) and selects the input terminal c for the horizontal effective scanning periods (Ha).

The D/A converter 34 converts the video signals Vid-out into analog data signals Vx that have a polarity specified by the scanning control circuit 20.

In order to prevent a direct current component from being applied to the liquid crystal 105, the voltage of each of the data signals Vx is alternately changed to a positive polarity voltage (that is higher than a voltage Vcnt that is the center of amplitude of the video signal) and a negative polarity voltage (that is lower than the voltage Vcnt) for each of vertical scanning periods, for example.

The voltage LCcom that is applied to the common electrode 108 is nearly equal to the voltage Vcnt. However, the voltage LCcom is set to a value that is lower than the voltage Vcnt in some cases in consideration of off-leak currents in the n-channel TFTs 116 and the like.

The scanning line driving circuit 130 supplies scanning signals Y1, Y2, Y3, . . . and Ym to the scanning lines 112 arranged in 1st, 2nd, 3rd, and m-th rows, respectively, on the basis of a control signal Yctr transmitted by the scanning control circuit 20.

Specifically, the scanning line driving circuit 130 selects the scanning lines 112 in order from the scanning line arranged in the 1st row to the scanning line arranged in the m-th row for the horizontal effective scanning periods (Ha) in order to write the video signals, as shown in FIG. 7. The scanning signals that are supplied to the selected scanning lines 112 are regarded as selection voltages V_{H} (H levels). In other words, the scanning line driving circuit 130 applies the selection voltage to the scanning lines 112 for the horizontal effective scanning periods (Ha), each of which starts after the time interval (horizontal blanking period (Hb)) elapses after the end of another one of the horizontal effective scanning periods (Ha). The horizontal effective scanning periods (Ha) can be regarded as video signal writing periods in which the video signals are written.

In addition, the scanning line driving circuit 130 sets the scanning signals Y1, Y2, Y3, . . . , and Ym to the high level for the setting periods (Hs) (in order to write the setting signal) that start earlier by the time period ΔT than the times at which the scanning signals are set to the high level in order to write the video signals.

For example, the scanning line driving circuit 130 applies the selection voltage to one of the scanning lines 112 for the setting period (Hs) that is included in the horizontal blanking period (Hb) and starts earlier by the time period ΔT than the time at which the selection voltage is applied to the scanning line 112 within the horizontal effective scanning period (Ha). When the scanning signal Y1 is to be set to the high level for the horizontal effective scanning period (Ha) for which the video signals Vid-in for the 1st row are supplied, the scanning signal Y(1+p) that is supplied to the scanning line arranged in the (1+p)th row is set to the high level for the setting period (Hs) included in the horizontal scanning period (H) that includes the horizontal effective scanning period (Ha) for which the video signals Vid-in for the 1st row are supplied. In this case, the (1+p)th row is located in a lower position by p rows than the 1st row. The value p is determined on the basis of the time period ΔT.

The scanning line driving circuit 130 sets the scanning signals to a non-selection voltage V_{L} (low level) for periods other than the periods for which the scanning signals are set to the high level in order to write the setting signal and the video signals. In FIG. 7, the vertical scanning period is represented by V and divided into a vertical effective scanning period (Va) and a vertical blanking period (Vb).

In the description, the ground potential (not shown) is used as a reference voltage (of 0 volts) for the scanning signals and the data signals. However, a voltage that is applied to each of the liquid crystal elements 120 is defined as a potential difference between the voltage LCcom applied to the common electrode 108 and a voltage applied to the pixel electrode 118 that corresponds to the liquid crystal element 120.

The data line driving circuit 140 receives the data signals Vx from the conversion circuit 30 and supplies the data signals Vx as data signals X1 to Xn to the data lines 114 arranged in the 1st to n-th columns on the basis of a control signal Xctr transmitted by the scanning control circuit 20. Specifically, the data line driving circuit 140 simultaneously supplies the data signals Vx (based on the setting signal or the precharge signal) to the data lines 114 arranged in the 1st to n-th columns for each of the horizontal blanking periods (Hb) and samples the data signals Vx (supplied to the data lines 114 arranged in the 1st to n-th columns) in order from the data signal Vx supplied to the data line 114 arranged in the 1st column to the data signal Vx supplied to the data line 114 arranged in the n-th column for each of the horizontal effective scanning periods (Ha).

Next, operations of the liquid crystal display device 1 are described below.

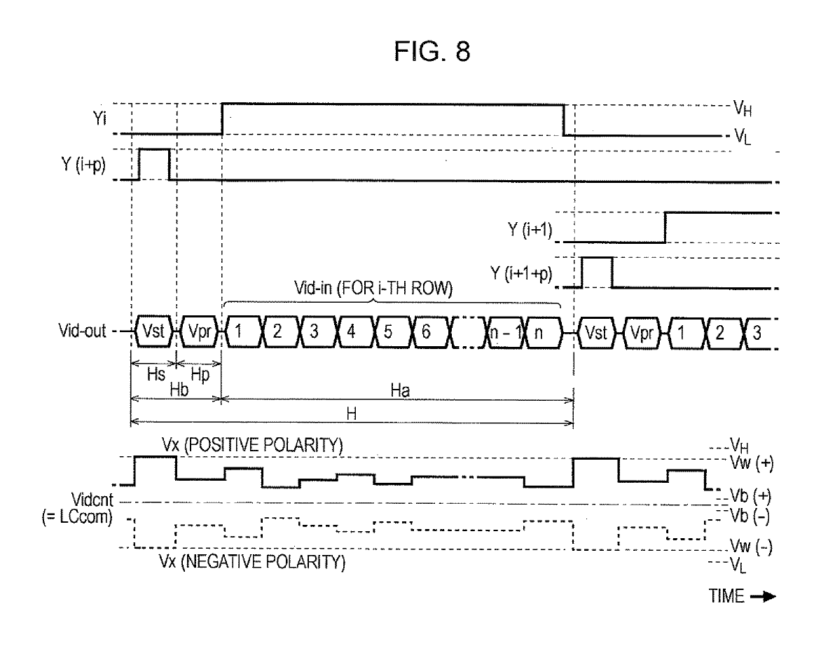

First, operations of the liquid crystal display device 1, which are performed for the horizontal scanning period (H) for which the video signals Vid-in for a certain row (i-th row) are supplied, are described with reference to FIG. 8.

The selector 32 selects the input terminal a for the setting period (Hs) that starts before the precharge period (Hp) and is included in the horizontal blanking period (Hb) of the horizontal scanning period (H). Thus, the selector 32 outputs, as the video signal Vid-out, the signal Vst that specifies the setting signal. The D/A converter 34 converts the signal Vst into a positive polarity voltage Vw(+) and outputs the converted signal as the data signal Vx. The voltage Vwt(+) is a data signal that corresponds to a positive polarity white level. In addition, the voltage Vw(+) is an example of a voltage that causes the voltage applied to the liquid crystal element 120 to be equal to or higher than the optical saturated voltage Vsat when the voltage Vw(+) is applied to the pixel electrode 118 of the liquid crystal element 120.

The data line driving circuit 140 simultaneously supplies the data signals Vx with the voltage Vwt(+) to the data lines 114 arranged in the 1st to n-th columns for the setting period (Hs).

The scanning signal Yi is set to the high level for the horizontal effective scanning period (Ha) included in the horizontal scanning period (H) for which the video signals V-id-in for the i-th row are supplied. For the setting period (Hs) that starts before the horizontal effective scanning period (Ha), the scanning signal Y(i+p) that is supplied to the scanning line 112 arranged in the (i+p)th row is set to the high level. In this case, the (i+p)th row is located in a lower position by p rows than the i-th row.

When the scanning signal Y(i+p) is set to the high level, the TFTs 116 arranged in the (i+p)th row are switched to an ON state. The sampled data signals with the voltage Vwt(+), which have been supplied to the data lines 114, are applied to the pixel electrodes 118 through the TFTs 116 that are in the ON state. Thus, the setting voltage that corresponds to a difference between the voltage Vwt(+) and the voltage LCcom is applied to each of the liquid crystal elements arranged in the (i+p)th row and the 1st to n-th columns while the voltage Vw(+) applied to each of the pixel electrodes 118 is higher than the voltage LCcom applied to the common electrode 108.

The setting period (Hs) is followed by the precharge period (Hp) in the horizontal blanking period (Hb). The selector 32 selects the input terminal b for the precharge period (Hp). The selector 32 outputs, as the video signal Vid-out, the signal Vpr that specifies a precharge voltage. The D/A converter 34 converts the signal Vpr into a positive polarity precharge voltage and outputs a signal with the positive polarity precharge voltage as the data signal Vx. In the present embodiment, the positive polarity precharge voltage is between the voltage Vwt(+) (corresponding to the white level) and the voltage Vbk(+) (corresponding to the black level).

The data line driving circuit 140 simultaneously supplies the data signals Vx to the data lines 114 arranged in the 1st to n-th columns for the precharge period (Hp). Thus, the data lines 114 arranged in the 1st to n-th columns are pre-charged to the voltage of the data signals Vx. For the precharge period (Hp), all the scanning signals Y1 to Yn are set to the low level, and all the TFTs 116 are in an OFF state. Therefore, the voltages applied to the liquid crystal elements 120 are not changed for the precharge period (Hp).

The precharged period (Hp) is followed by the horizontal effective scanning period (Ha). For the horizontal effective scanning period (Ha), the selector 32 selects the input terminal c. Thus, the selector 32 outputs the video signal Vid-in as the video signal Vid-out. For the horizontal effective scanning period (Ha) for the i-th row, the video signals Vid-in (Vid-out) specify a gradation of the pixel to be displayed in the i-th row and the 1st column, a gradation of the pixel to be displayed in the i-th row and the 2nd column, a gradation of the pixel to be displayed in the i-th row and the 3rd column, . . . , and a gradation of the pixel to be displayed in the i-th row and the n-th column in this order. The D/A converter 34 converts the video signals Vid-out into positive polarity data signals Vx, and the data line driving circuit 140 sequentially samples the data signals X1 to Xn (data signals Vx) that are supplied to the data lines 114 arranged in the 1st to n-th columns, as shown in FIG. 8. For example, the data signal Vx that corresponds to the i-th row and the 3rd column is sampled as the data signal X3 that is supplied to the data line 114 arranged in the 3rd column.

For the horizontal effective scanning period (Ha) for the i-th row, the scanning signal Yi is set to the high level, and the TFTs 116 arranged in the i-th row are in the ON state. The sampled data signals (supplied to the data lines 114) are applied to the pixel electrodes 118 through the TFTs 116 that are in the ON state. Thus, voltages that correspond to differences between the data signals and the voltage LCcom or correspond to the gradations are applied to the liquid crystal elements arranged in the i-th row and the 1st to n-th columns while the voltages applied to the pixel electrodes 118 are higher than the voltage LCcom applied to the common electrode 108.

The liquid crystal elements 120 are in the normally black mode in the present embodiment. Thus, each of the data signals Vx has a waveform so that when the data signal Vx has a positive polarity, the data signal Vx has a higher voltage than the reference voltage Vcnt as the specified gradation is closer to the white level, and when the data signal Vx has a negative polarity, the data signal Vx has a lower voltage than the reference voltage Vcnt as the specified gradation is closer to the white level.

Specifically, when the data signal Vx has a positive polarity, the voltage of the data signal Vx is in a range of the voltage Vw(+) (corresponding to the white level) to the voltage Vb(+) (corresponding to the black level) and is different from the reference voltage Vcnt by a value corresponding to the gradation. When the data signal Vx has a negative polarity, the voltage of the data signal Vx is in a range of a voltage Vw(−) (corresponding to the white level) to a voltage Vb(−) (corresponding to the black level) and is different from the reference voltage Vent by a value corresponding to the gradation.

The voltage Vw(+) and the voltage Vw(−) have a symmetric relationship with respect to the voltage Vcnt. In addition, the voltage Vb(+) and the voltage Vb(−) have a symmetric relationship with respect to the voltage Vcnt.

When the reference voltage Vcnt is equal to the voltage LCcom, a difference between the voltage of the data signal and the voltage LCcom is applied to each of the liquid crystal elements.

The above describes the operations for the horizontal scanning period (H) for which the video signals Vid-in for the i-th row are supplied.

The video signals Vid-in are supplied to the liquid crystal elements arranged in the 1st, 2nd, 3rd, 4th, . . . , (m−1)-th, and m-th rows in this order, while the scanning signals Y1, Y2, Y3, Y4, . . . , Y(m−1) and Ym are sequentially set to the high level for the horizontal effective scanning periods (Ha) included in the vertical effective scanning period (Va) for which the video signals Vid-in are supplied, as shown in FIG. 7. Thus, voltages that correspond to the video signals Vid-in are applied to the liquid crystal elements arranged in the 1st, 2nd, 3rd, 4th, . . . , (m−1)th, and m-th rows.

In addition, the scanning signals Y1, Y2, . . . , Y(m−1) and Ym are sequentially set to the high level for setting periods (Hs) that start earlier by the time period ΔT than the start times of the horizontal effective scanning periods (Ha) (for which the scanning signals Y1, Y2, . . . , Y(m−1) and Ym are sequentially set to the high levels), respectively. Thus, the setting voltage that corresponds to the setting signal is applied to the liquid crystal elements arranged in the 1st, 2nd, . . . , (m−1)th, and m-th rows. Therefore, the liquid crystal molecules start moving and the liquid crystal elements can eliminate the effect of the electric field applied in the horizontal direction.

In the present embodiment, the polarity of the setting signal that is supplied for each of the setting periods is the same as the polarity of the data signal that is supplied after the time period ΔT and is based on the video signal. The setting periods (Hs) for the 1st, 2nd, 3rd, . . . , and (p−1)th rows are included in the vertical scanning period (V) that is followed by the vertical scanning period (V) shown in FIG. 7. The scanning control circuit 20 instructs the D/A converter 34 to set the polarity of the setting signal so that the polarity of the setting signal is the same as the polarities of the data signals supplied for the horizontal effective scanning period (Ha) that starts after the time period ΔT.

When the setting signal is written and the time period ΔT elapses, the voltages that corresponds to the video signals are written in the liquid crystal elements arranged in each of the rows.

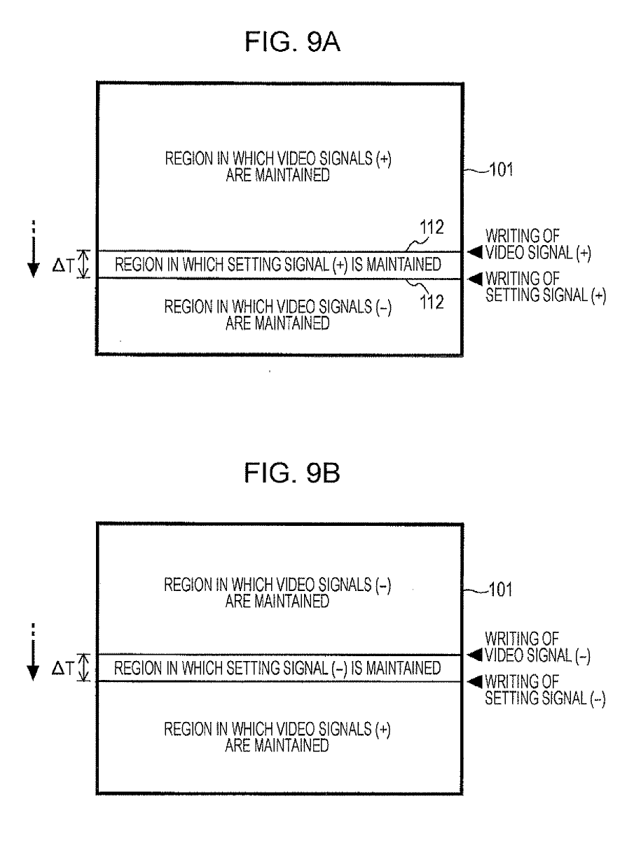

FIGS. 9A and 9B show the relationship between the writing process and the display region 101. FIG. 9A shows the case where the data signal that has a positive polarity and corresponds to the video signal is written.

In this case, when the scanning line 112 is selected for the setting period (Hs) in order to write the setting signal having a positive polarity, the scanning line 112 arranged in the row that is located in a higher position by p rows than the row in which the scanning line 112 selected in order to write the setting signal is arranged is selected for the horizontal effective scanning period (Ha) that follows the setting period (Hs) so that the data signal having a positive polarity is written. Each of the selected scanning lines 112 is arranged in the row that is lower the row in which the previously selected scanning line 112 is arranged, while the scanning line 112 arranged in the row that is located in a higher position by p rows than the row in which the scanning line 112 selected for the setting period (Ha) is selected for the horizontal effective scanning period (Ha).

A portion of the display region 101, which is located on the lower side of the selected scanning line 112, is a region in which signals that are not rewritten (or are written when the scanning lines 112 are previously selected) are maintained. Another portion of the display region 101, which is located on the upper side of the selected scanning line 112, is a region in which signals that are rewritten when the scanning lines 112 are selected are maintained. In FIGS. 9A and 9B, the scanning line 112 selected in order to write the setting signal is reselected in order to write the video signal after the time period ΔT elapses.

FIG. 9B shows the case where the data signal that has a negative polarity and is based on the video signal is written. When the scanning line 112 is selected in order to write the setting signal having a negative polarity, the scanning line 112 arranged in the row that is located in a higher position by p rows than the row in which the selected scanning line 112 is arranged is selected so that the data signal having the negative polarity is written.

In the present embodiment, even when each of the liquid crystal elements is affected by an electric field applied in the horizontal direction when the voltage that corresponds to the video signal is applied to the liquid crystal element in the previous vertical scanning period, the liquid crystal molecules are moved by the application of the setting voltage. Thus, the liquid crystal element can eliminate the effect of the electric field applied in the horizontal direction. In the state in which there is no effect of the electric field applied in the horizontal direction, the voltage that corresponds to the video signal is applied to the liquid crystal element in the next vertical scanning period. In the present embodiment, therefore, it is possible to suppress the occurrence of a display error that is caused by a reverse tilt domain.

In the present embodiment, it is not necessary to change the structure of the liquid crystal panel 100. Thus, the aperture ratio of the liquid crystal panel 100 is not reduced. In addition, the liquid crystal display device can be applied to existing liquid crystal panels that have been made without consideration of the structures of the liquid crystal panels.

In the present embodiment, the setting voltage is applied to all the pixels regardless of an image that is to be displayed, and the time period ΔT that corresponds to the period for which the setting voltage is maintained is shorter than the response time Tr. Thus, the user almost does not perceive changes in the transmittances of the liquid crystal elements due to the setting voltage and a display error (in which an image that is not based on the video signals is displayed).

In addition, since it is not necessary to analyze the video signals Vid-in, the configurations of the circuits are not complicated.

In the present embodiment, the polarity of the setting signal applied for each of the setting periods is the same as the polarity of the data signal that is supplied after the time period ΔT elapses and is based on to the video signal. The state immediately before the data signal based on the video signal is written is the same as the state in which the setting voltage is applied. Thus, while the polarities of the signals are well-balanced by alternate current driving, it is possible to write the signals without a display error. In addition, since the setting voltage is equal to or higher than the optical saturated voltage Vsat, there is a high possibility that the writing of the data signals based on the video signals is performed in a discharging direction that allows for a high-speed response. In the present embodiment, the voltage of the setting signal is set to the highest voltage (corresponding to the white level) in the normally black mode. Thus, the writing of each of the data signals based on the video signals can be performed in the discharging direction unless the voltage of the data signal is set to the voltage that corresponds to the white level.

The invention is not limited to the aforementioned embodiment and can be applied to various modified examples.

For example, the invention can be applied to a region scanning method described in JP-A-2004-177930. In the region scanning method, scanning lines arranged in the 1st, (m/2+1)th, 2nd, (m/2+2)th, 3rd, (m/2+3)th, 4th, (m/2+4)th rows are selected in this order. Each of the scanning lines selected every even time is located in the row that is separated by a distance equivalent to the half of the m rows from the previously selected scanning line. In the region scanning method, for example, the scanning lines arranged in the 1st, 2nd, 3rd, etc. rows are selected so that data signals that have a positive polarity and are based on video signals are written, while the scanning lines arranged in the (m/2+1)th, (m/2+2)th, (m/2+3)th, etc. rows are selected so that data signals that have a negative polarity and are based on video signals are written.

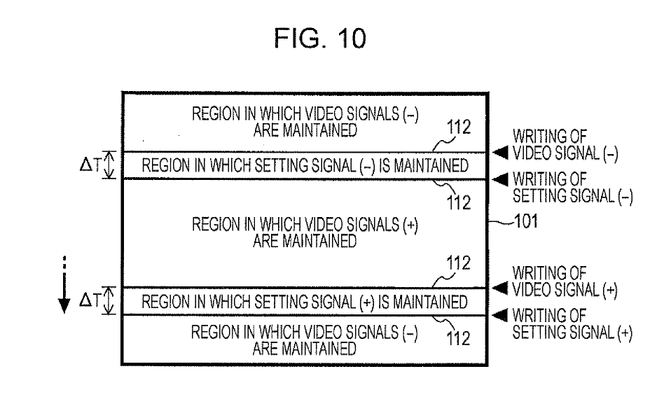

For example, as shown in FIG. 10, when each of the scanning lines 112 is to be selected in order to write the data signals that are obtained by converting the video signals and have a positive polarity, the scanning line 112 may be selected so that the setting signal having a positive polarity is written at the time that is earlier by the time period ΔT than the time when the scanning line 112 is selected in order to write the data signals. In addition, when each of the scanning lines 112 is to be selected in order to write the data signals that are obtained by converting the video signals and have a negative polarity, the scanning line 112 may be selected so that the setting signal having a negative polarity is written at the time that is earlier by the time period ΔT than the time when the scanning line 112 is selected in order to write the data signals.

This configuration suppresses crosstalk and the occurrence of a display error caused by a reverse tilt domain while uniformity of a display screen is maintained.

When the time period ΔT is set to 1 millisecond or less, the transmittances are almost not changed by the application of the setting voltage. However, when the time period ΔT is set to a value that is close to the response time Tr and the liquid crystal elements are in the normally black mode, the transmittance of each of the liquid crystal elements to which the setting voltage is applied finally becomes a value that is close to 100% (refer to FIG. 5B). Thus, a whitening effect, which causes the display screen to be bright (white), may occur.

On the other hand, when the proportion of the liquid crystal elements to which the setting voltage is applied among all the liquid crystal elements is reduced from 100% and a voltage that corresponds to a dark gradation is applied to the liquid crystal elements instead of the setting voltage, the degree of the whitening effect can be reduced. However, when the proportion is reduced without consideration of the arrangement of the liquid crystal elements, the effect of suppressing the occurrence of a reverse tilt domain cannot be expected.

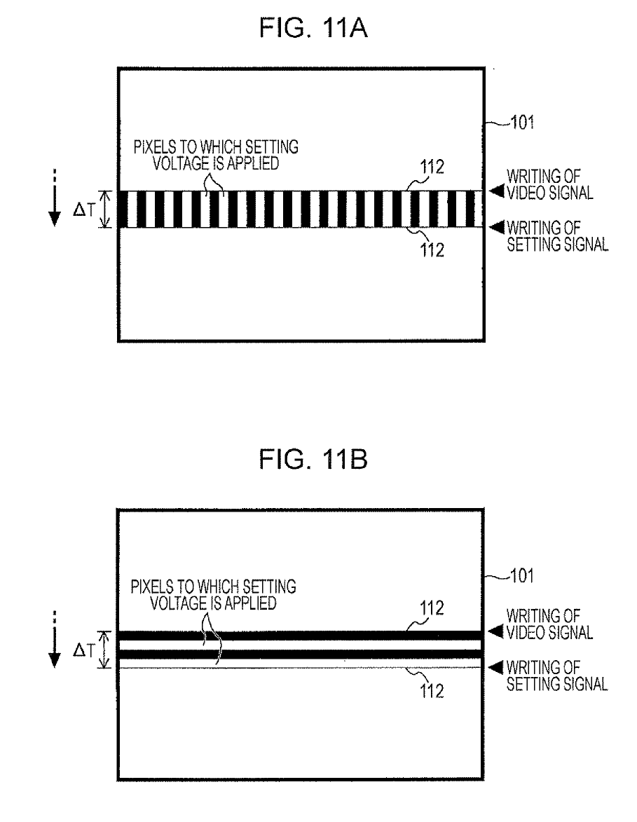

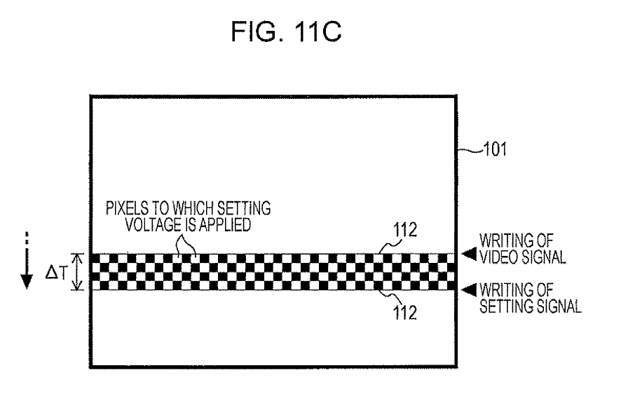

When a certain one of the liquid crystal elements, to which the setting voltage is not applied, is adjacent to another one of the liquid crystal elements, to which the setting voltage is applied (or in which the liquid crystal molecules start moving), the liquid crystal element (to which the setting voltage is not applied) is not easily affected by an electric field applied in the horizontal direction. As shown in FIG. 11A, the pixels to which the setting voltage is applied may be arranged in every other column. Specifically, the data line driving circuit 140 may supply the setting signal to the data lines arranged in the odd-numbered columns and supply an off signal (data signal that causes the pixels to become dark in the normally black mode) to the data lines arranged in the even-numbered columns for the setting periods (Hs).

In addition, as shown in FIG. 11B, the pixels, to which the setting voltage is applied, may be arranged in every other row. Specifically, the data line driving circuit 140 may supply the setting signal to the data lines arranged in the 1st to n-th columns when the scanning lines arranged in the odd-numbered rows are selected for the setting periods (Hs) and supply the off signal to the data lines arranged in the 1st to n-th columns when the scanning lines arranged in the even-numbered rows are selected for the setting periods (Hs).

Furthermore, as shown in FIG. 11C, the pixels, to which the setting voltage is applied, may be arranged in a checkered pattern by combining the arrangement shown in FIG. 11A with the arrangement shown in 11B. Specifically, when the scanning lines arranged in the odd-numbered rows are selected for the setting periods (Hs), the data line driving circuit 140 may supply the setting signal to the data lines arranged in the odd-numbered columns and supply the off signal to the data lines arranged in the even-numbered rows; and when the scanning lines arranged in the even-numbered rows are selected for the setting periods (Hs), the data line driving circuit 140 may supply the off signal to the data lines arranged in the odd-numbered columns and supply the setting signal to the data lines arranged in the even-numbered columns.

In each of the aforementioned three configurations, it is possible to suppress the whitening effect and the formation of a reverse tilt domain in the normally black mode even when the time period ΔT is set to a value that is close to the response time Tr.

The region scanning method shown in FIG. 10 may be used for the configuration shown in FIG. 11A, 11B or 11C.

In the embodiment and the modified examples, the liquid crystal elements 120 is not limited to the transparent type and may be of reflective type. The liquid crystal elements 120 is not limited to the normally black mode and may be in a normally white mode in which the liquid crystal elements 120 become a white state when the liquid crystal elements 120 are driven by the TN method and no voltage is applied to the liquid crystal elements 120. When the liquid crystal elements 120 are in the normally white mode, the relationship between a voltage applied to each of the liquid crystal elements 120 and the transmittance (reflectance) of the liquid crystal element 120 is represented by voltage-transmittance characteristics shown in FIG. 4B. As the voltage applied to the liquid crystal element 120 is higher, the transmittance of the liquid crystal element 120 is lower. When the liquid crystal elements 120 are in the normally white mode, the liquid crystal elements 120 exhibit response characteristics shown in FIG. 5C.

The whitening effect that occurs in the normally black mode corresponds to a blackening effect that occurs in the normally white mode. In the normally white mode, the off signal serves as a data signal that causes the pixels to become bright. Thus, when the configuration shown in FIG. 11A, 11B or 11C is used, the blackening effect can be suppressed.

### Electronic Devices

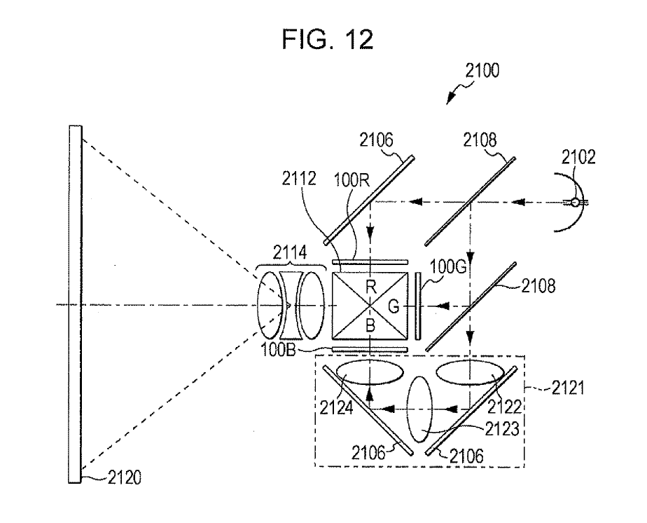

As an electronic device that uses the liquid crystal display device according to the present embodiment, a projection-type display device (projector) that uses the liquid crystal panels 100 as light valves is described below. FIG. 12 is a plan view of the configuration of the projector.

As shown in FIG. 12, the projector 2100 has a lamp unit 2102 therein. The lamp unit 2102 includes a white light source such as a halogen lamp. Light emitted by the lamp unit 2102 is split into three primary color light components (red, green and blue color components) by three mirrors 2106 and two dichroic mirrors 2108 so that the red, green and blue light components reach light valves 100R, 100G and 100B, respectively. The optical path of the blue light component is longer than the optical paths of the red and green light components. Thus, the blue light component reaches the light valve 100B through a relay lens system 2121 that includes an incident lens 2122, a relay lens 2123 and an output lens 2124 in order to prevent a part of the blue light component from being lost.

The projector 2100 includes three liquid crystal display devices that are provided for the red, green and blue color light components, respectively. Each of the liquid crystal display devices includes the liquid crystal panel 100. Each of the light valves 100R, 100G and 100R has the same configuration as the liquid crystal panel 100. An external higher-level circuit supplies video signals to specify gradations of the red, green and blue primary color components so that the light valves 100R, 100G and 100E are driven. The light components are modulated by the light valves 100R, 100G and 100B and incident on a dichroic prism 2112 from three directions. The red and blue light components are refracted at 90 degrees by the dichroic prism 2112, while the green light component passes straight through the dichroic prism 2112. Then, images of the primary color light components are combined to form a color image. After that, the color image is projected on a screen 2120 by a projection lens group 2114.

The red light component is incident on the light valve 100R through one of the dichroic mirrors 2108, while the green and blue light components are incident on the light valves 100G and 100B through the two dichroic mirrors 2108. Thus, a color filter is not required. The images of the red and blue light components are projected after the red and blue light components pass through the light valves 100R and 100B and are reflected by the dichroic prism 2112. The image of the green light component is projected without being refracted by the dichroic prism 2112 after the green light component passes through the light valve 100G. Thus, the direction of horizontal scanning performed by the light valves 100R and 100E is the opposite to the direction of horizontal scanning performed by the light valve 100G so that a mirror-reversed image is displayed.

The electronic device can be applied to a television, a viewfinder type video tape recorder, a direct monitor viewing type video tape recorder, a car navigation system, a pager, an electronic notebook, a calculator, a word processor, a workstation, a video phone, a point-of-sale (POS) terminal, a digital still camera, a mobile phone, a device that has a touch panel, and the like, in addition to the projector described with reference to FIG. 12. The liquid crystal display device can be applied to the electronic devices.

The entire disclosure of Japanese Patent Application No. 2009-205682, filed Sep. 7, 2009 is expressly incorporated by reference herein.

1. A liquid crystal display device comprising:
pixel that corresponds to intersection of scanning line and data line and that each change the transmittance or reflectance of a liquid crystal element by means of a pair of electrodes;
a scanning line driving circuit that selects scanning line and applies a selection voltage to the selected scanning line; and
a data line driving circuit that applies writing voltages through the data line to the pixel that corresponds to the selected scanning line,
wherein the scanning line driving circuit applies the selection voltage to the selected scanning line for video signal writing periods and setting periods that start before the video signal writing periods, respectively,
the data line driving circuit supplies, to the pixel, data signals with voltages corresponding to video signals for the video signal writing periods and supplies, to the pixel, a setting signal with a predetermined voltage for the setting periods, and
each of the setting periods is shorter than a response time required for the transmittance or reflectance of each of the liquid crystal element to change from 0% to 100% or a response time required for the transmittance or reflectance of each of the liquid crystal element to change from 100% to 0%.

2. The liquid crystal display device according to claim 1, wherein
the setting periods are set to 1 millisecond or less and start before the video signal writing periods, respectively.

3. The liquid crystal display device according to claim 1, wherein
the setting signal is a voltage that causes the voltages applied to the liquid crystal element to be equal to or higher than an optical saturated voltage.

4. The liquid crystal display device according to claim 3, wherein
the video signal writing periods are horizontal effective scanning periods for the video signals, and
the setting periods are included in respective horizontal blanking periods for the video signals.

5. The liquid crystal display device according to claim 4, wherein
the data line driving circuit supplies the setting signal and the data signals, which have a positive or negative polarity with respect to a predetermined reference potential, and
when the selection voltage is to be applied to one of the selected scanning line for the horizontal effective scanning period after the selection voltage is applied to the selected scanning line for the setting period, the polarity of the setting signal supplied for the setting period is the same as the polarities of the data signals supplied for the horizontal effective scanning period.

6. The liquid crystal display device according to claim 4, wherein
the data line driving circuit alternately supplies, to the data line, the setting signal and a signal other than the setting signal for the setting periods.

7. The liquid crystal display device according to claim 4, wherein
the data line driving circuit repeats the supply of the setting signal to the data line for every other setting period and the supply of a signal other than the setting signal to the data line for the next setting period.

8. A method for driving a liquid crystal display device that has pixel that corresponds to intersection of scanning line and data line and that each include a liquid crystal element that has liquid crystal provided between a pixel electrode and a common electrode and a switching element that electrically connects the pixel electrode to the data line that corresponds to the liquid crystal element when a selection voltage is applied to the scanning line that corresponds to the liquid crystal element, comprising:
selecting the scanning line for video signal writing periods and setting periods that start before the video signal writing periods, respectively, and applying the selection voltage to the selected scanning line;
supplying, through the data line to the pixel, data signals with voltages corresponding to video signals for the video signal writing periods; and
supplying, through the data line to the pixel, a setting signal with a predetermined voltage for the setting periods, wherein
each of the setting periods is shorter than a response time required for the transmittance or reflectance of the liquid crystal element to change from 0% to 100% or a response time required for the transmittance or reflectance of the liquid crystal element to change from 100% to 0%.

9. An electronic device comprising the liquid crystal display device according to claim 1.

10. An electronic device comprising the liquid crystal display device according to claim 2.

11. An electronic device comprising the liquid crystal display device according to claim 3.

12. An electronic device comprising the liquid crystal display device according to claim 4.

13. An electronic device comprising the liquid crystal display device according to claim 5.

14. An electronic device comprising the liquid crystal display device according to claim 6.

15. An electronic device comprising the liquid crystal display device according to claim 7.
